(19) United States
(12) Patent Application Publication
(10) Pub. No.: US 2025/0202610 A1
(43) Pub. Date: Jun. 19, 2025

(54) SYSTEMS AND METHODS FOR PREVENTING TEMPORAL OVERLAP BETWEEN DATA PACKETS OF BROADCAST STREAMS

(71) Applicant: Bose Corporation, Framingham, MA (US)

(72) Inventors: Rasmus Abildgren, Skørping (DK); Casper Stork Bonde, Støvring (DK)

(73) Assignee: Bose Corporation, Framingham, MA (US)

(21) Appl. No.: 18/542,010

(22) Filed: Dec. 15, 2023

(51) Int. Cl. H04J 3/06

(52) U.S. Cl. CPC H04J 3/0682; H04J 3/0632; H04J 3/0644

(57) ABSTRACT

A method for transmitting a broadcast stream is provided. The method includes transmitting, by a first device, a first broadcast stream that uses timing information based on a clock of the first device. The method further includes monitoring transmissions from a second device to determine whether the first broadcast stream will temporally overlap with a second broadcast stream at a future time. The second device transmits the second broadcast stream. The second broadcast stream may use timing information based on a clock of the second device. The method further includes, in response to determining that the first broadcast stream will temporally overlap with the second broadcast stream, adjusting timing related to the first broadcast stream in an attempt to prevent the temporal overlap of the first broadcast stream and the second broadcast stream. In some examples, the monitored transmissions include advertising packets transmitted by the second device.

### FIELD OF THE DISCLOSURE

The present disclosure is generally directed to transmitting broadcast streams, more particularly, to systems and methods for preventing temporal overlap between data packets of two or more broadcast streams.

### BACKGROUND

Bluetooth radios operate based on clock signals provided by crystal oscillators. The clock signals generated by the crystal oscillators are rarely 100% accurate. Further, the accuracy of the crystal oscillators can be impacted by factors such as age, temperature, etc. As Bluetooth radios transmit data packets over a period of time, a drift in the cadence of the transmitted data packets may be observed in comparison to absolute time. To compensate for this drift, the Bluetooth standard enables a receiving device to know the accuracy of the crystal oscillator of the transmitting device when the transmitting device is in sleep mode, which is also when the crystal oscillator is most inaccurate. The receiving device defines a receiving window for the reception of data packets from the transmitting device. The size of the receiving window will vary depending on the time to the previously received data packet and the accuracy of the crystal oscillator in sleep mode.

However, when multiple transmitting devices with Bluetooth radios transmit at the same time, the data packet trains transmitted by each radio may drift in such a way that they will overlap in the time domain. For a receiving device which is attempting to receive data packets from each of the transmitting devices, it will have to prioritize which of the transmission trains to follow when an overlap in time occurs. Thus, the receiving device will be unable to receive all of the data packets transmitted by each transmitting device.

### SUMMARY

The present disclosure is generally directed to transmitting broadcast streams, more particularly, to systems and methods for preventing temporal overlap between data packets of two or more broadcast streams, such as isochronous streams transmitted according to the Bluetooth Low Energy (LE) Audio protocol. Two devices transmit broadcast streams in a shared broadcast zone. The first device transmits a first broadcast stream according to a clock of the first device, while the second device transmits a second broadcast stream according to a clock of the second device. The first device monitors wireless transmissions from the second device to determine if the first broadcast stream will temporally overlap with the second broadcast stream in the future. If so, the first device adjusts the timing of the first broadcast stream to prevent the future temporal overlap. In this way, the first broadcast stream can compensate for the drift of one or both of the broadcast streams to allow a receiving device to receive all of the data packets of each stream.

In some examples, the first device monitors periodic advertisements of the second device. These periodic advertisements are transmitted based on the clock as the second device, and thus will experience the same amount of drift as the second broadcast stream. The processor then adjusts the timing of the first broadcast stream to prevent future temporal overlap. In some cases, the processor adds a notch offset to the first broadcast stream to prevent the first broadcast stream from overlapping with the second broadcast stream. Alternatively, the first device could monitor the second broadcast stream rather than the periodic advertisements. However, monitoring the continuous second broadcast stream will consume significantly more power and resources than monitoring the periodic advertisements.

In some examples, both the first and second devices are enabled to adjust their respective clocks to prevent future broadcast stream overlap. Accordingly, the periodic advertisements transmitted by both the first and second devices may include anti-collision data indicating that the transmitting device is configured to implement the aforementioned timing adjustment. In this scenario, the notch offsets implemented by each device may be coordinated to prevent the temporal overlap or other undesirable effects.

In some examples, the first device monitors the transmissions from the second device indirectly. Rather than receiving transmissions from the second device, the first device may receive timing information regarding the second device from a wired or wireless network. This configuration may be particularly useful where the first device is out of a broadcasting zone of the second device, but the respective broadcasting zones of each device at least partially overlap.

Generally, in one aspect, a method for transmitting a broadcast stream is provided. The method includes transmitting, by a first device, a first broadcast stream that uses timing information based on a clock of the first device.

The method further includes monitoring transmissions from a second device to determine whether the first broadcast stream will temporally overlap with a second broadcast stream at a future time. The second device is configured to transmit the second broadcast stream. The second broadcast stream may use timing information based on a clock of the second device.

The method further includes, in response to determining that the first broadcast stream will temporally overlap with the second broadcast stream, adjusting timing related to the first broadcast stream in an attempt to prevent the temporal overlap of the first broadcast stream and the second broadcast stream.

According to an example, the monitored transmissions may include a plurality of advertising packets transmitted by the second device. At least one of the plurality of advertising packets may include anti-collision data.

According to an example, the monitored transmissions may include a plurality of data packets of the second broadcast stream.

According to an example, the monitored transmissions may be periodic.

According to an example, the timing information related to the first broadcast stream is adjusted by adjusting the clock.

According to an example, the first broadcast stream and the second broadcast stream may be isochronous streams.

According to an example, the first broadcast stream and the second broadcast stream are transmitted according to a Bluetooth Low Energy (BLE) Audio protocol.

According to an example, the monitoring of the transmissions from the second device is performed by the first device.

According to an example, the adjusting of the timing information related to the first broadcast stream comprises shifting at least one transmission interval of the first broadcast stream according to a notch offset.

According to an example, the notch offset is determined based on the monitored transmissions from the second device and the first broadcast stream. The notch offset may be further determined based on anti-collision data included in the monitored transmissions from the second device.

According to an example, the monitoring of the transmissions comprises wirelessly receiving the transmissions.

According to an example, the monitoring of the transmissions comprises receiving timing information corresponding to the transmissions via a wired or wireless network. The second device may be positioned outside of a first broadcast zone of the first device, the first device may be positioned outside of a second broadcast zone of the second device, and the first broadcast zone may at least partially overlap with the second broadcast zone.

Generally, in another aspect, a device for transmitting a broadcast stream is provided. The device includes a transmitting module and at least one processor.

The at least one processor is configured to transmit a first broadcast stream using the transmitting module. The first broadcast stream uses timing information based on a clock of the device.

The at least one processor is further configured to monitor transmissions from a second device to determine whether the first broadcast stream will temporally overlap with a second broadcast stream at a future time, the second device configured to transmit the second broadcast stream.

The at least one processor is further configured to, in response to determining that the first broadcast stream will temporally overlap with the second broadcast stream, adjusting timing related to the first broadcast stream in an attempt to prevent the temporal overlap of the first broadcast stream with the second broadcast stream.

According to an example, the monitored transmissions may include a plurality of advertising packets transmitted by the second device.

According to an example, the monitored transmissions may include a plurality of data packets of the second broadcast stream.

According to an example, adjusting of the timing related to the first broadcast stream may include shifting at least one transmission interval of the first broadcast stream according to a notch offset. The notch offset is determined based on the monitored transmissions from the second device and the first broadcast stream.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also can appear in any disclosure incorporated by reference should be accorded a meaning most consistent with the particular concepts disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic view of a system for wireless communication, in accordance with an example.

FIG. 2 illustrates the impact of drift on data packet transmission, in accordance with an example.

FIG. 3 illustrates two broadcast streams impacted by drift, in accordance with an example.

FIG. 4 illustrates two broadcast streams and associated periodic advertising packets impacted by drift, in accordance with an example.

FIG. 5 illustrates applying a notch offset to a data packet transmission, in accordance with an example.

FIG. 6 illustrates two broadcast streams implementing a notching offset scheme to avoid data packet overlap, in accordance with an example.

FIG. 7 illustrates a pair of broadcasting devices connected to a network and having overlapping broadcast zones, in accordance with an example.

FIG. 8 is a schematic diagram of a first device, in accordance with an example.

FIG. 9 is a schematic diagram of a second device, in accordance with an example.

FIG. 10 is a schematic diagram of a third device, in accordance with an example.

FIG. 11 is a flow chart of a method for transmitting a broadcast stream, in accordance with an example.

### DETAILED DESCRIPTION

The present disclosure is generally directed to transmitting broadcast streams, more particularly, to systems and methods for preventing temporal overlap between two or more broadcast streams, such as isochronous streams transmitted according to the Bluetooth Low Energy (LE) Audio protocol. Two devices transmit broadcast streams in a shared broadcast zone. The first device transmits a first broadcast stream according to a clock of the first device, while the second device transmits a second broadcast stream according to a clock of the second device. The first device monitors wireless transmissions from the second device to determine if the first broadcast stream will temporally overlap with the second broadcast stream in the future. If so, the first device adjusts the timing of the first broadcast stream to prevent the future temporal overlap. In this way, the first broadcast stream can compensate for the drift of one or both of the broadcast streams to allow a receiving device to receive all of data packets of each stream.

The terms “broadcast stream” or “broadcast isochronous stream” as used herein, in addition to including their ordinary meaning or their meaning known to those skilled in the art, is intended to refer to an isochronous data stream which does not require a preestablished communications link to be established between the source device sending data and the audio device receiving data and does not require acknowledgements or negative acknowledgements to be sent or received.

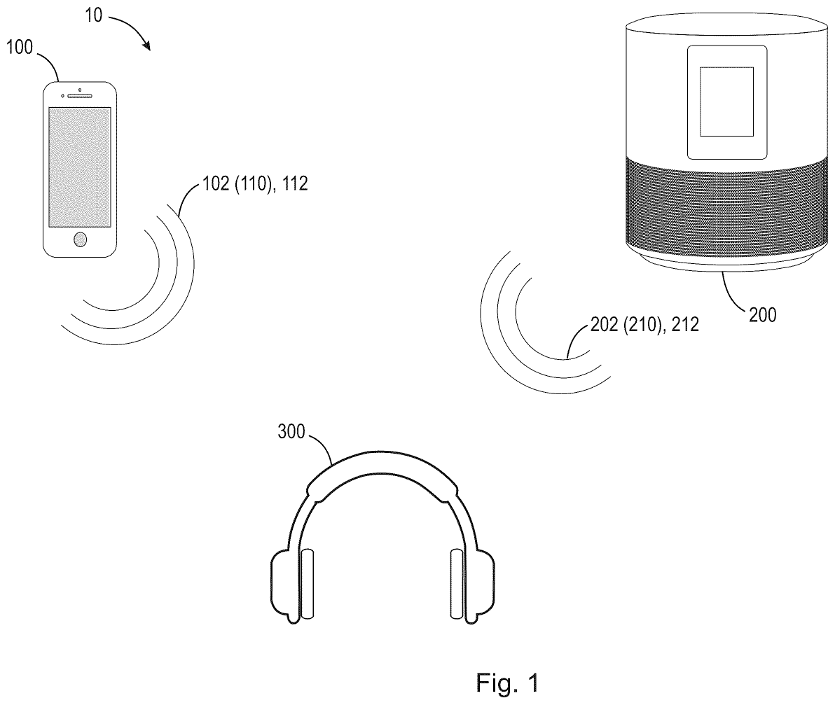

The following description should be read in view of FIGS. 1-11.

FIG. 1 is a schematic view of the components of system 10 according to the present disclosure. In some examples, the system 10 includes a first device 100, a second device 200, and a third device 300. In the non-limiting example of FIG. 1, the first device 100 is a smartphone, the second device 200 is a smart speaker, and the third device is an audio headset.

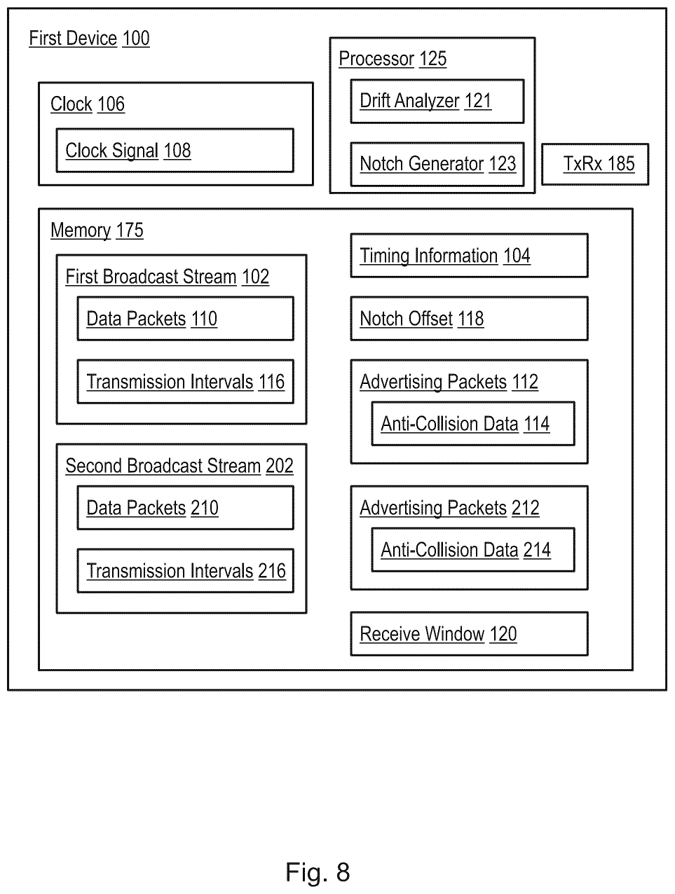

The first device 100 is configured to transmit a first broadcast stream 102. The first broadcast stream 102 includes a series of data packets 110. As shown in FIG. 8, the first device 100 includes a crystal oscillator clock 106 configured to generate a clock signal 108. The first broadcast stream 102 conveys data packets 110 according to timing information 104 based on the clock signal 108. In some examples, the first device 100 also transmits one or more advertising packets 112. The advertising packets 112 provide information enabling another device to receive the first broadcast stream 102 transmitted by the first device 100.

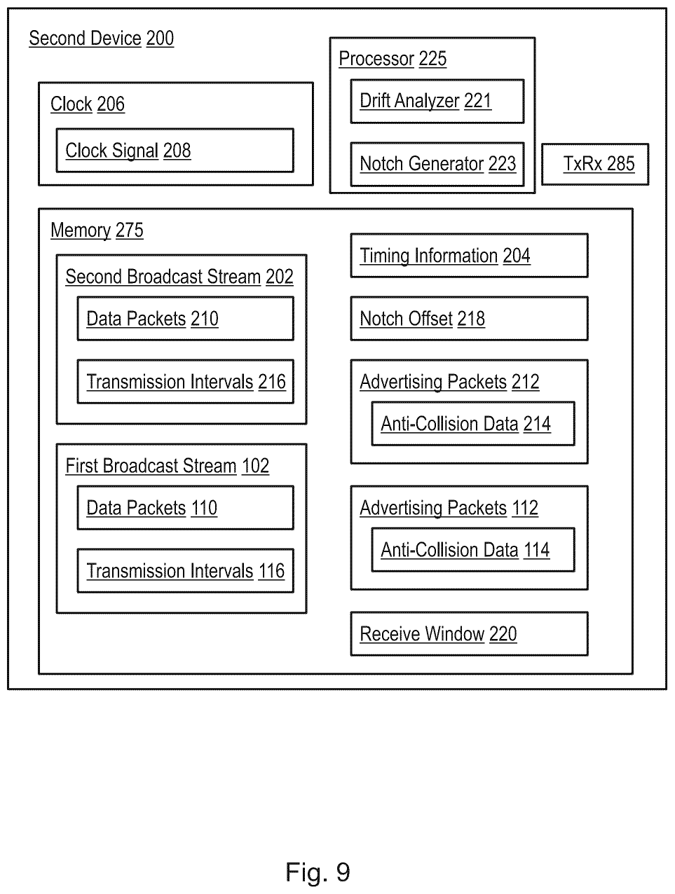

The second device 200 is configured to transmit a second broadcast stream 202. The second broadcast stream 202 includes a series of data packets 210. As shown in FIG. 9, the second device 200 includes a crystal oscillator clock 206 configured to generate a clock signal 208. The second broadcast stream 202 conveys data packets 210 according to timing information 204 based on the clock signal 208. In some examples, the second device 200 also transmits one or more advertising packets 212. The advertising packets 212 provide information enabling another device to receive the second broadcast stream 202 transmitted by the second device 200.

The third device 300 is configured to receive the first and second broadcast streams 102, 202. In further examples, the first device 100 may also be configured to receive the second broadcast stream 202 and/or the advertising packets 212 transmitted by the second device 200. Similarly, the second device 200 may also be configured to receive the first broadcast stream 102 and/or the advertising packets 112 transmitted by the first device 100. In some examples, and as will be demonstrated with respect to subsequent figures, the advertising packets 112, 212 may be transmitted periodically.

In further examples, the first and second devices 100, 200 may be any devices capable of transmitting the first and second broadcast streams 102, 202. While the first and second devices 100, 200 are shown as non-wearable audio devices (smartphones and speakers), in further examples, one or both of the first and second devices 100, 200 may be wearable audio devices. Similarly, in even further examples, the third device 300 may be any device capable of receiving the first and second broadcast streams 102, 202. While the third device 300 is shown as a wearable audio device (more specifically, an audio headset), in further examples, the third device may be a non-wearable audio device. While the example of FIG. 1 includes two broadcast streams 102, 202, other example systems may include more than two broadcast streams. Indeed, other example systems may include any practical number of broadcasts streams transmitted by any practical number of devices.

The term “wearable audio device”, as used in this application, in addition to including its ordinary meaning or its meaning known to those skilled in the art, is intended to mean a device that fits around, on, in, or near an ear (including open-car audio devices worn on the head or shoulders of a user) and that radiates acoustic energy into or towards the car. Wearable audio devices are sometimes referred to as headphones, earphones, earpieces, headsets, earbuds or sport headphones, and can be wired or wireless. A wearable audio device includes an acoustic driver to transduce audio signals to acoustic energy. The acoustic driver can be housed in an earcup. While some of the figures and descriptions following can show a single wearable audio device, having a pair of earcups (each including an acoustic driver) it should be appreciated that a wearable audio device can be a single stand-alone unit having only one earcup. Each earcup of the wearable audio device can be connected mechanically to another earcup or headphone, for example by a headband and/or by leads that conduct audio signals to an acoustic driver in the car cup or headphone. A wearable audio device can include components for wirelessly receiving audio signals. A wearable audio device can include components of an active noise reduction (ANR) system. Wearable audio devices can also include other functionality such as a microphone so that they can function as a headset. While FIG. 1 shows examples of an over-the-car audio headset, in other examples the wearable audio device can be an in-the-car headphone form factor, an eyeglass form factor, an on-car, around-car, behind-car, or near-car headset. In some examples, the wearable audio device can be an open-car device that includes an acoustic driver to radiate acoustic energy towards the car while leaving the car open to its environment and surroundings.

As will be described with reference to subsequent figures, the first and second devices 100, 200 may be configured to monitor the transmissions (including the broadcast streams 102, 202 and/or advertising packets 112, 212) from the other device 100, 200. In particular, the transmissions may be monitored for trends indicative of future temporal overlap of the broadcast streams 102, 202. By monitoring the transmissions of the other device 100, 200, the first and/or second device 100, 200 may adjust the timing information 104, 204 used to transmit the broadcast streams 102, 202 to prevent the data packets 110, 210 of each stream 102, 202 from overlapping in time due to drift of one or both of the streams 102, 202.

In a preferred example, the data packets 110, 210 conveyed by the first and second broadcast streams 102, 202 include audio data capable of being processed by the third device 300 to render audio via one or more acoustic transducers. Accordingly, if the data packets 110, 210 of the first and second broadcast streams 102, 202 do not overlap, the third device 300 may render audio corresponding to both the first and second devices 100, 200. In other examples, the data packets 110, 210 conveyed by the first and/or second broadcast streams 102, 202 may include non-audio data. In some examples, the non-audio data may include data captured by one or more sensors of the first or second devices 100, 200, such as motion sensors.

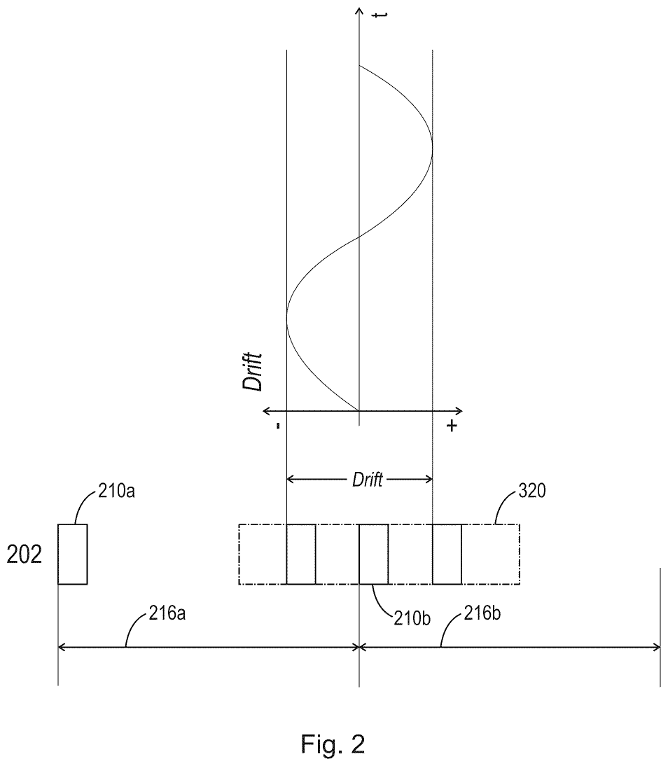

FIG. 2 illustrates the impact of drift on data packets 210 transmitted by the second device 200 via the second broadcast stream 202. The second broadcast stream 202 is defined by a series of transmission intervals 216, such that one of a plurality of data packets 210 is transmitted at the beginning of each transmission interval 216. As shown in FIG. 2, a first data packet 210a is transmitted at the beginning of the first transmission interval 216a, and a second data packet 210b is transmitted as the beginning of the second transmission interval 210b. The timing of the transmission may be impacted by drift due to the crystal oscillator of the clock 206 of the second device 200. In the example of FIG. 2, the pattern of the drift may be substantially sinusoidal, as the drift may increase or decrease the time between transmission of the first and second data packets 210a, b.

In this example, the data packets 210 are received by the third device 300. The third device 300 implements a receiving window 320 defining a time period where the third device 300 is prepared to receive one of the data packets 210 of the second broadcast stream 202. As shown in FIG. 2, the receiving window 320 is wide enough to capture the second data packet 210 even at maximum positive or negative drift.

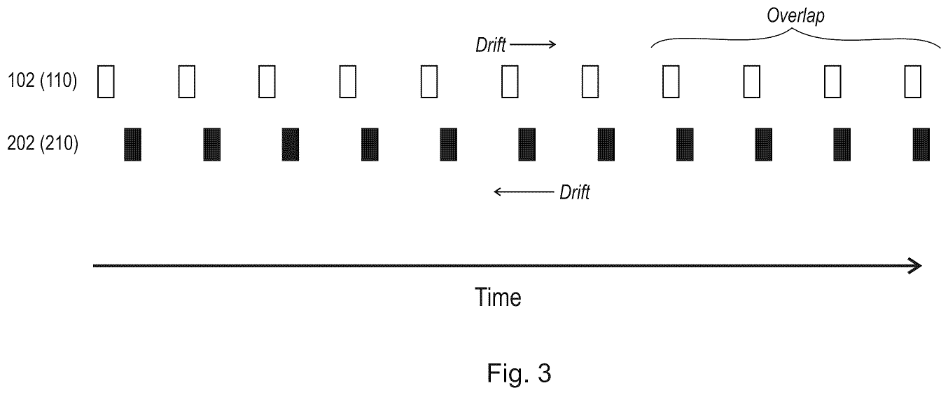

While the drift of a single broadcast stream 200 may be compensated for by a receiving window 320 of the receiving device 300 as shown in FIG. 2, additional complications may arise in environments with multiple broadcast streams 100, 200 drifting in different directions and/or at different drift rates. This is demonstrated in FIG. 3, which shows a first broadcast stream 102 conveying a first series of data packets 110 and a second broadcast stream 202 conveying a second series of data packets 210. However, due to the first broadcast stream 102 drifting in a first temporal direction, and the second broadcast stream 202 drifting in the opposite temporal direction, the data packets 110, 210 of the broadcast streams 102, 202 eventually temporally overlap. During this overlap period, a receiving device, such as third device 300, will be unable to receive data packets 110, 210 from both broadcast streams 102, 202 and must prioritize one stream over the other. If the broadcast streams 102, 202 are audio streams, the user of the third device 300 may experience a degraded audio experience due to the unreceived data packets 110, 210.

In the example of FIG. 3, the first device 100 can monitor the drift associated with the clock 206 of the second device 200 by tracking the timing of each second data packet 210 conveyed by the second broadcast stream 202 and received by the first device 100. Similarly, the second device 200 can monitor the drift associated with the clock 106 of the first device 100 by tracking the timing of each first data packet 110 conveyed by the first broadcast stream 102 and received by the second device 200. However, receiving and processing each data packet 110, 210 uses a significant amount of processing power. This power usage may be particularly wasteful when the receiving device does not intend to use the data conveyed by the data packets 110, 210 (such as by rendering audio frames via an audio speaker), but is rather simply monitoring the drift associated with data packets 110, 210 of the broadcast streams 102, 202. Further, this power usage may pose particular issues with wireless devices having limited battery capacity.

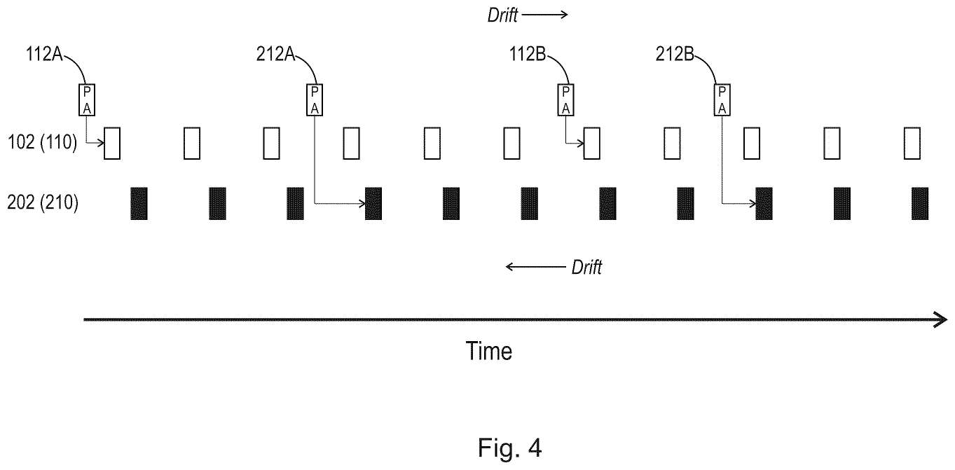

FIG. 4 illustrates the two broadcast streams 102, 202 and conveyed data packets 110, 210 as shown in FIG. 3. However, FIG. 4 also illustrates a first group of advertising packets 112 transmitted by the first device 100, and a second group of advertising packets 212 transmitted by the second device 200. The first group of advertising packets 112 provides information enabling another device to receive the first broadcast stream 102 transmitted by the first device 100. Similarly, the second group of advertising packets 212 provides information enabling another device to receive the second broadcast stream 202 transmitted by the second device 200. The advertising packets 112, 212 may be transmitted at any appropriate interval. In the non-limiting example of FIG. 4, the first advertising packets 112 are transmitted according to a first periodic interval, while the second periodic advertisements 212 are transmitted according to a second periodic interval, with the first periodic interval being slightly longer than the second periodic interval.

As can be seen in FIG. 4, the advertising packets 112, 212 are impacted by drift in the same manner as the data packets 110, 210 of the broadcast streams 102, 202. More specifically, the first advertising packets 112 are transmitted based on the same clock signal 108 as the first data packets 110, resulting in the first advertising packets 112 drifting to the same degree as the first data packets 110. Similarly, the second advertising packets 212 are transmitted based on the same clock signal 208 as the second data packets 210, resulting in the second advertising packets 212 drifting to the same degree as the first data packets 210. Accordingly, a receiving device may be able to determine the drift of the broadcast streams 102, 202 based on the advertising packets 112, 212 transmitted by the same devices 100, 200.

Determining drift based on advertising packets 112, 212 may result in significant power savings when compared to monitoring data packets 110, 210 conveyed by the broadcast streams 102, 202. Monitoring advertising packets 112, 212 allows the monitoring device to save power by periodically (rather than constantly) monitoring. In some examples, the monitoring device may periodically monitor for advertising packets 112, 212 according to shorter time periods, such as every 1, 2, 3, 5, 10, 15, or 30 seconds. In other examples, the monitoring device may periodically monitor for advertising packets 112, 212 according to longer time periods, such every 1, 2, 3, 5, 10, 15, or 30 minutes. Thus, longer time periods reflect less frequent monitoring, resulting in power saving. The frequency of the periodic monitoring could be adjusted based on whether or not the monitored device(s) are actively broadcasting. For example, the periodic monitoring could be more frequent when the monitored device(s) are actively broadcasting, and less frequent when the monitored device(s) are not actively broadcasting. Further, in other examples, if significant drift was recently detected and offset, thereby reducing the current drift to a minimal value, less frequent periodic monitoring may be implemented to save power until the system estimates that the drift could significantly increase.

In a non-limiting example, the second device 200 transmitting broadcast stream 202 acts as the monitoring device. The broadcast stream 202 conveys data packets 210 drifting in a negative time direction. The second device 200 does not intend to use data conveyed by the data packets 110 of the first broadcast stream 102 transmitted by the first device 100. Accordingly, to monitor the drift associated with the first broadcast stream 102, the second device 200 captures the periodic advertising packets 112 transmitted by the first device 100. The second device 200 then processes the timing of the received periodic advertising packets 112 via a drift analyzer 221 (as shown in FIG. 9) to determine if and when the data packets 110 of the first broadcast stream 102 may temporally overlap with the data packets 210 of the second broadcast stream 102.

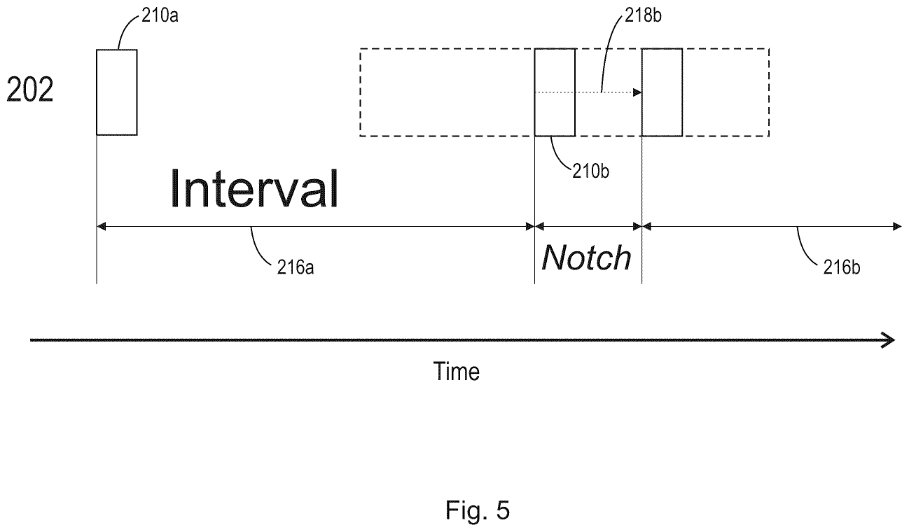

To prevent this temporal overlap, a notch generator 223 (as shown in FIG. 9) generates one or more notch offsets 218 to temporally shift one or more data packets 210 of the second broadcast stream 202. An example of a notch offset 218 is shown in FIG. 5. FIG. 5 illustrates the second broadcast stream 202 conveying a first data packet 210a during a first interval 216a and a second data packet 210b during a second interval 216b. To prevent the second packet 210b from temporally overlapping with a data packet 110 of the first broadcast stream 102, the second interval 216b is delayed according to a notch offset 218b. Accordingly, the transmission of the second data packet 210b is also delayed according to the notch offset 218b. The notch offset 218b can be incorporated by the clock 206 of the second device 200 to temporally shift the clock signal 208 of the clock 206. Temporally shifting the clock signal 208 will result in the timing of all processes of the second device 200 to be delayed according to the notch offset 218b. While the notch offset 218b shown in FIG. 5 increases the length of time between the first and second data packets 210a, 210b, in other examples, the notch offset 218b could reduce the length of time between the first and second data packets 210a, 210b. In many examples, the drift is a very small period of time. Accordingly, a notch offset 218 may not need to be applied to every transmission interval 216. For example, a notch offset 218 could only be applied every 10-100 transmission intervals 216 to prevent temporal overlap with other streams. The notch offset 218b could be any appropriate amount of time to prevent temporal overlap. In some non-limiting examples, the notch offset 218b could be approximately 2 microseconds.

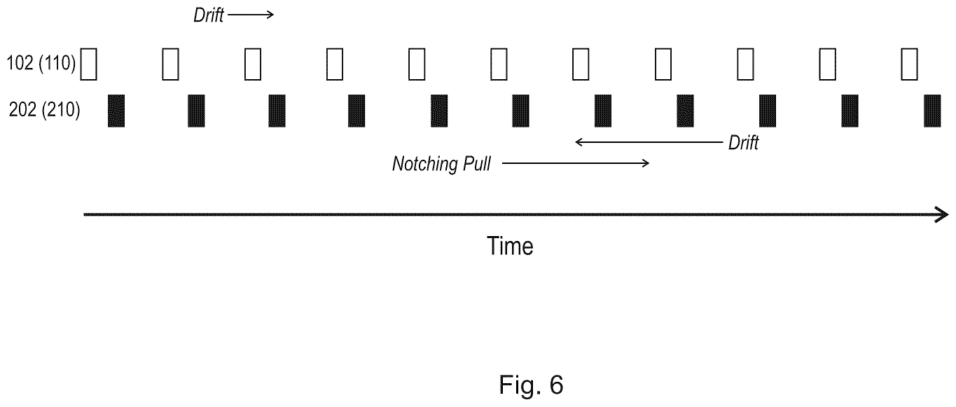

The result of using one or more notching offsets 218 is shown in FIG. 6. By shifting one or more data packets 210 of the second broadcast stream 202 according to one or more notching offsets 218, temporal overlap of the first and second data packets 110, 210 can be avoided. The length of time of the notch offsets 218 may increase or decrease over time based on the observed drift of the first broadcast stream 102.

In some examples, each of the broadcasting devices 100, 200 may be configured to monitor the transmissions of the other device 100, 200 to add notch offsets 118, 218 into their respective broadcast streams 102, 202 for collision avoidance. More particularly, the first device 100 monitors the advertising packets 212 transmitted by the second device 200 to evaluate the drift of the data packets 210 of the second broadcast stream 202. Based on the evaluated drift, the first device 100 applies one or more notch offsets 118 to its clock 106 to prevent the data packets 118 of the first broadcast stream 102 from temporally overlapping with the data packets 218 of the second broadcast stream 202. Similarly, the second device 200 monitors the advertising packets 112 transmitted by the first device 100 to evaluate the drift of the data packets 110 of the first broadcast stream 102. Based on the evaluated drift, the second device 200 applies one or more notch offsets 218 to its clock 206 to prevent the data packets 218 of the second broadcast stream 202 from temporally overlapping with the data packets 118 of the first broadcast stream 102.

However, in some examples, if both devices 100, 200 are simultaneously independently implementing the notch offsets 118, 218, the collision avoidance impact of the notch offset 118, 218 may be reduced or even entirely cancelled. For example, if two data packets 110, 210 will overlap due to drift, and each device 100, 200 attempts to avoid the overlap by implementing notch offsets 118, 218 of the same value, the two data packets 110, 210 will still overlap, only at a slightly later time. To avoid this situation, in some examples, one or both devices 100, 200 may include anti-collision data 114, 214 in their respective advertising packets 112, 212. The anti-collision data 114, 214 identifies the devices 100, 200 transmitting the advertising packet 112, 212 as implementing an anti-collision scheme using notch offsets 118, 218. Accordingly, to ensure collision avoidance occurs, the devices 100, 200 may modify the implemented notch offsets 118, 218 when one or more other devices 100, 200 are utilizing an anti-collision scheme. For example, if both devices 100, 200 are utilizing the anti-collision scheme, the notch offsets 118, 218 implemented by one or both of the devices 100, 200 may be reduced or increased to avoid temporal overlap of the data packets 110, 210 of the broadcast streams 102, 202. While the example of FIG. 6 illustrates collision avoidance between two broadcast streams 102, 202, in other examples, the same collision avoidance techniques may be applied to systems with more than two broadcast streams.

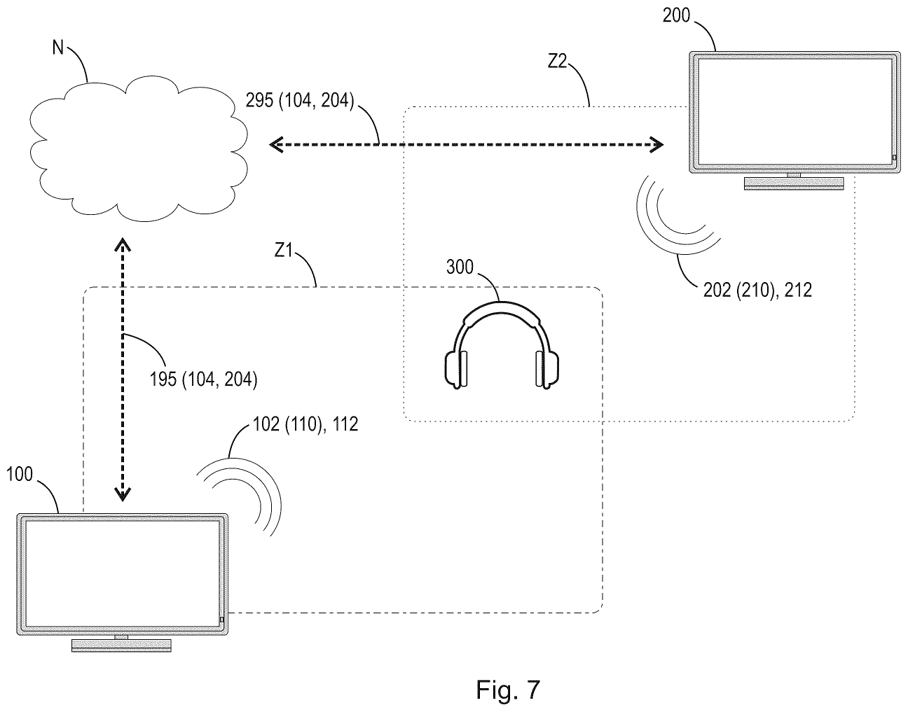

FIG. 7 illustrates a variation of the system 10 of FIG. 1 where the first and second devices 100, 200 are each smart televisions. The first device 100 is configured to transmit a first broadcast stream 102 and a plurality of advertising packets 112. The first broadcast stream 102 includes a series of data packets 110. The range of the transmissions (including the broadcast stream 102 and the advertising packets 112) of the first device 100 is defined by the first broadcast zone Z1 shown in FIG. 7. Similarly, the second device 200 is configured to transmit a second broadcast stream 202 and a plurality of advertising packets 212. The second broadcast stream 202 includes a series of data packets 210. The range of the transmissions (including the broadcast stream 202 and the advertising packets 212) of the second device 200 is defined by the second broadcast zone Z2 shown in FIG. 7. While the example of FIG. 7 includes two broadcast streams 102, 202, other example systems may include more than two broadcast streams. Indeed, other example systems may include any practical number of broadcasts streams transmitted by any practical number of devices.

As can be seen in FIG. 7, the third device 300 (embodied as an audio headset), is positioned within both the first and second broadcast zones Z1, Z2. In one illustrative example, the first device 100 and the second device 200 may be smart televisions arranged at opposite ends of an airport terminal displaying flight information (such as arrival and/or departure information), while the third device 300 is an audio headset worn by a traveler seated approximately halfway between the first and second devices 100, 200. Accordingly, the third device 300 is positioned to receive transmissions from both the first and second devices 100, 200. However, as the first device 100 is positioned outside of the second broadcast zone Z2, the first device 100 is unable to receive the second broadcast stream 202 or the advertising packets 212 transmitted by the second device 200. Similarly, as the second device 200 is positioned outside of the first broadcast zone Z1, the second device 200 is unable to receive the first broadcast stream 102 or the advertising packets 112 transmitted by the first device 100. Thus, if the first or second device 100, 200 wishes to implement a collision avoidance scheme (to prevent temporal overlap at the third device 300), the devices 100, 200 must monitor the transmissions of the other device 100, 200 through an alternative means.

As further shown in FIG. 7, the first device 100 is connected to a network N via a first network connection 195. Similarly, the second device 200 is also connected to the network N via a second network connection 295. The first and second network connections 195, 295 may be formed by any combination of wired and/or wireless connections and/or components. Further, the first and second network connections 195, 295 may be unidirectional or bidirectional.

In the example of FIG. 7, the first device 100 transmits timing information 104 to the network N via wireless connection 195. The timing information 104 represents the timing of the transmission of the data packets 110 of the first broadcast stream 102, inclusive of the impact of any drift experienced by the clock 106 of the first device 100. The network N then conveys this timing information 104 to the second device 200 via the second network connection 295. By receiving the timing information 104, the second device 200 can now adjust the timing of the transmission of the second broadcast stream 202 to avoid future overlap with the first broadcast stream 102 such as by including one or more notch offsets 218 in the second broadcast stream 202.

Similarly, the second device 200 transmits timing information 204 to the network N via wireless connection 295. The timing information 204 represents the timing of the transmission of the data packets 210 of the second broadcast stream 202, inclusive of the impact of any drift experienced by the clock 206 of the second device 200. The network N then conveys this timing information 204 to the first device 100 via the first network connection 195. By receiving the timing information 204, the first device 200 can now adjust the timing of the transmission of the first broadcast stream 102 to avoid future overlap with the second broadcast stream 202 such as by including one or more notch offsets 118 in the first broadcast stream 102.

FIG. 8 schematically illustrates the first device 100 previously depicted in FIGS. 1 and 7. As shown in the non-limiting examples of FIGS. 1 and 7, the first device 100 may be embodied as a smartphone or a smart television. However, in other examples, the first device 100 may be any other device capable of transmitting the first broadcast stream 102 and/or monitoring transmissions from the second device 200. The first device 100 includes the clock 106, the processor 125, the memory 175, and the transceiver 185. The clock 106 may be a crystal oscillator configured to generate a clock signal 108. The processor 125 is configured to execute one or more applications, such as a drift analyzer 121 and a notch generator 123. The memory 175 is configured to store the first broadcast stream 102 (defined by data packets 110 and transmission intervals 116), timing information 104 to transmit the first broadcast stream 102, advertising packets 112 (including, in some examples, anti-collision data 114), notch offsets 118, receive windows 120, a second broadcast stream 202 (defined by data packets 210 and transmission intervals 216), and advertising packets 212 (including, in some examples, anti-collision data 214) transmitted by the second device 200. The transceiver 185 is configured to transmit the first broadcast stream 102 and advertising packets 112. In some examples, the transceiver 185 is further configured to receive the second broadcast stream 202 and/or the advertising packets 212.

FIG. 9 schematically illustrates the second device 200 previously depicted in FIGS. 1 and 7. As shown in the non-limiting example of FIGS. 1 and 7, the second device 200 may be embodied as a smart speaker or a smart television. However, in other examples, the second device 200 may be any other device capable of transmitting the second broadcast stream 202 and/or monitoring transmissions from the first device 100. The second device 200 includes the clock 206, the processor 225, the memory 275, and the transceiver 285. The clock 206 may be a crystal oscillator configured to generate a clock signal 208. The processor 225 is configured to execute one or more applications, such as a drift analyzer 221 and a notch generator 223. The memory 275 is configured to store the second broadcast stream 202 (defined by data packets 210 and transmission intervals 216), timing information 204 to transmit the second broadcast stream 202, advertising packets 212 (including, in some examples, anti-collision data 214), notch offsets 218, receive windows 220, a first broadcast stream 102 (defined by data packets 110 and transmission intervals 116), and advertising packets 112 (including, in some examples, anti-collision data 114) transmitted by the first device 100. The transceiver 285 is configured to transmit the second broadcast stream 202 and advertising packets 212. In some examples, the transceiver 285 is further configured to receive the first broadcast stream 102 and/or the advertising packets 112.

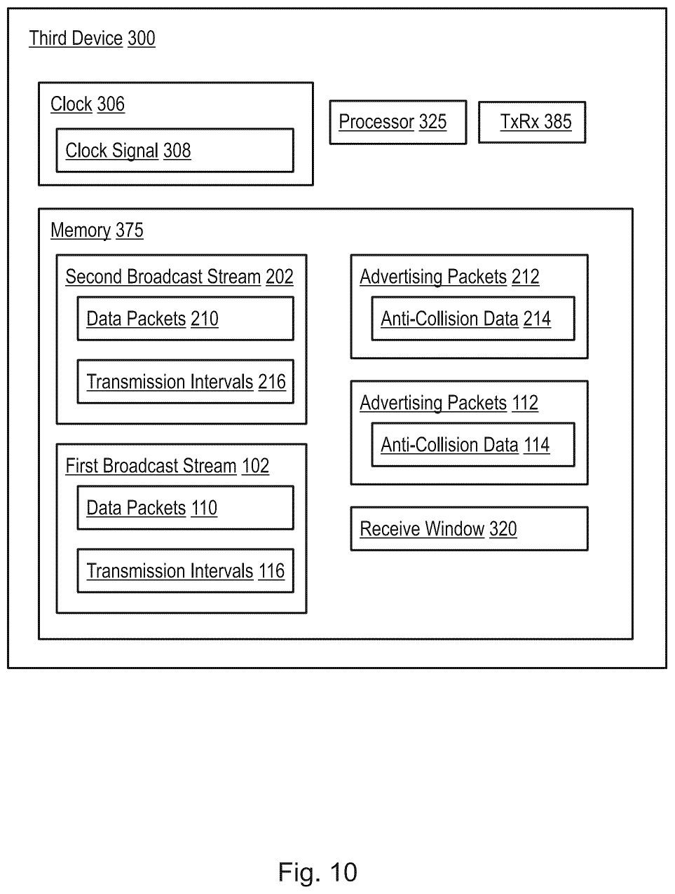

FIG. 10 schematically illustrates the third device 300 previously depicted in FIGS. 1 and 7. As shown in the non-limiting example of FIGS. 1 and 7, the third device 300 may be embodied as an audio headset. However, in other examples, the third device 300 may be any other device capable of receiving the first and second broadcast streams 102, 202. The third device 300 includes the clock 306, the processor 325, the memory 375, and the transceiver 385. The clock 306 may be a crystal oscillator configured to generate a clock signal 308. The memory 275 is configured to store the first broadcast stream 102 (defined by data packets 110 and transmission intervals 116), the second broadcast stream 202 (defined by data packets 210 and transmission intervals 216), advertising packets 112 (including, in some examples, anti-collision data 114), advertising packets 212 (including, in some examples, anti-collision data 214), and receive windows 320. The transceiver 285 is configured to receive the broadcast streams 102, 202 and the advertising packets 112, 212.

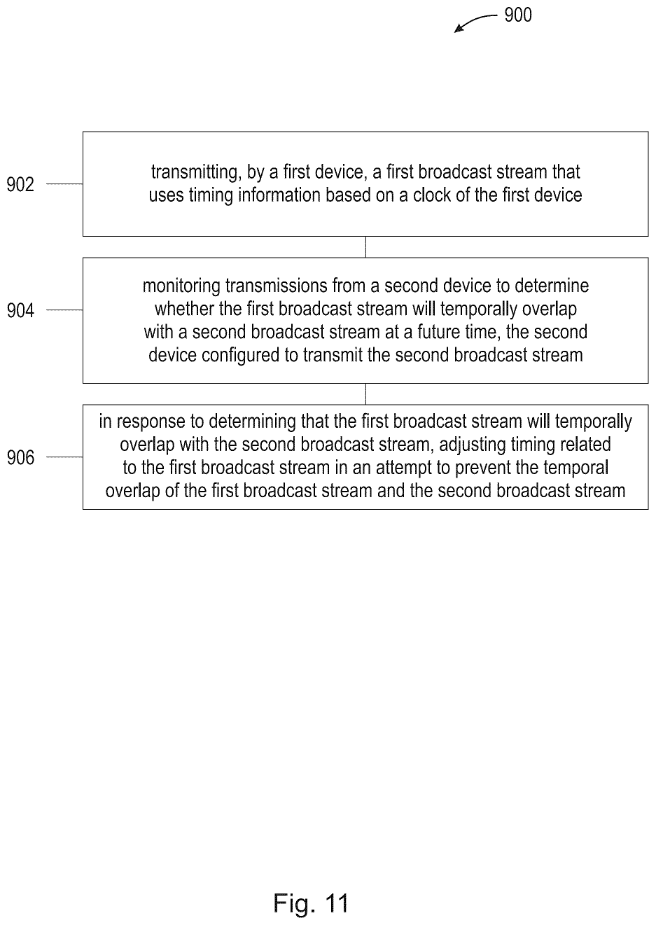

FIG. 11 is a flow chart of a method 900 for transmitting a broadcast stream, according to various embodiments of the invention. Referring to FIGS. 1-11, the method 900 includes, in step 902, transmitting, by a first device 100, a first broadcast stream 102 that uses timing information 104 based on a clock 106 of the first device 100.

The method 900 further includes, in step 904, monitoring transmissions from a second device 200 to determine whether the first broadcast stream 102 temporally overlaps with a second broadcast stream 202. The second device 200 is configured to transmit the second broadcast stream 202. The second broadcast stream 202 may use timing information 204 based on a clock 206 of the second device 208.

The method 900 further includes, in step 906, in response to determining that the first broadcast stream 102 temporally overlaps with the second broadcast stream 202, adjusting timing related to the first broadcast stream 102 in an attempt to prevent the temporal overlap of the first broadcast stream 102 and the second broadcast stream 202.

According to an example, the monitored transmissions may include a plurality of advertising packets 212 transmitted by the second device 200. At least one of the plurality of advertising packets 212 may include anti-collision data 214.

According to an example, the monitored transmissions may include a plurality of data packets 210 of the second broadcast stream 202.

According to an example, the monitored transmissions may be periodic.

According to an example, the timing information 104 related to the first broadcast stream is adjusted by adjusting the clock 106.

According to an example, the first broadcast stream 102 and the second broadcast stream 202 may be isochronous streams.

According to an example, the first broadcast stream 102 and the second broadcast stream 202 are transmitted according to a BLE Audio protocol.

According to an example, the monitoring of the transmissions from the second device 200 is performed by the first device 100.

According to an example, the adjusting of the timing information 104 related to the first broadcast stream 102 comprises shifting at least one transmission interval 116 of the first broadcast stream 102 according to a notch offset 118.

According to an example, the notch offset 118 is determined based on the monitored transmissions from the second device 200 and the first broadcast stream 100. The notch offset 118 may be further determined based on anti-collision data 214 included in the monitored transmissions from the second device 200.

According to an example, the monitoring of the transmissions comprises wirelessly receiving the transmissions.

According to an example, the monitoring of the transmissions comprises receiving timing information corresponding to the transmissions via a wired or wireless network. The second device 200 may be positioned outside of a first broadcast zone Z1 of the first device 100, the first device 100 may be positioned outside of a second broadcast zone Z2 of the second device 200, and the first broadcast zone Z1 may at least partially overlap with the second broadcast zone Z2.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

1. A method for transmitting a broadcast stream, comprising:
transmitting, via a transceiver of a first device, a first broadcast stream that uses timing information based on a clock of the first device;
monitoring, via the transceiver of the first device, a plurality of periodic advertising packets transmitted from a second device while the first device transmits the first broadcast stream to determine whether the first broadcast stream will temporally overlap with a second broadcast stream at a future time based on a drift of the second broadcast stream, wherein the drift is determined based on the monitored plurality of periodic advertising packets, the second device configured to transmit the second broadcast stream; and
in response to determining that the first broadcast stream will temporally overlap with the second broadcast stream, adjusting timing related to the first broadcast stream in an attempt to prevent the temporal overlap of the first broadcast stream and the second broadcast stream.

2. The method of claim 1, wherein the second broadcast stream uses timing information based on a clock of the second device.

3. (canceled)

4. The method of claim 1, wherein at least one of the plurality of periodic advertising packets comprises anti-collision data.

5. (canceled)

6. (canceled)

7. The method of claim 1, wherein the timing information related to the first broadcast stream is adjusted by adjusting the clock.

8. The method of claim 1, wherein the first broadcast stream and the second broadcast stream are isochronous streams.

9. The method of claim 8, wherein the first broadcast stream and the second broadcast stream are transmitted according to a Bluetooth Low Energy (BLE) Audio protocol.

10. (canceled)

11. The method of claim 1, wherein the adjusting of the timing information related to the first broadcast stream comprises shifting at least one transmission interval of the first broadcast stream according to a notch offset.

12. The method of claim 11, wherein the notch offset is determined based on the plurality of periodic advertising packets transmitted from the second device and the first broadcast stream.

13. The method of claim 12, wherein the notch offset is further determined based on anti-collision data included in the plurality of periodic advertising packets transmitted from the second device.

14. (canceled)

15. (canceled)

16. The method of claim 1, wherein the second device is positioned outside of a first broadcast zone of the first device, the first device is positioned outside of a second broadcast zone of the second device, and the first broadcast zone at least partially overlaps with the second broadcast zone.

17. A device for transmitting a broadcast stream, comprising:
transceiver; and
at least one processor configured to:
transmit, via the transceiver, a first broadcast stream using the transceiver, wherein the first broadcast stream uses timing information based on a clock of the device,
monitor, via the transceiver, a plurality of periodic advertising packets transmitted from a second device while the device transmits the first broadcast stream to determine whether the first broadcast stream will temporally overlap with a second broadcast stream at a future time based on a drift of the second broadcast stream, wherein the drift is determined based on the monitored plurality of periodic advertising packets, the second device configured to transmit the second broadcast stream, and
in response to determining that the first broadcast stream will temporally overlap with the second broadcast stream, adjusting timing related to the first broadcast stream in an attempt to prevent the temporal overlap of the first broadcast stream with the second broadcast stream.

18. (canceled)

19. (canceled)

20. The device of claim 17, wherein the adjusting of the timing related to the first broadcast stream comprises shifting at least one transmission interval of the first broadcast stream according to a notch offset, and wherein the notch offset is determined based on the plurality of periodic advertising packets transmitted from the second device and the first broadcast stream.
